(19) United States
(12) Patent Application Publication
(10) Pub. No.: US 2016/0019572 A1
(43) Pub. Date: Jan. 21, 2016

(54) METHOD AND SYSTEM FOR EFFICIENTLY DISTRIBUTING COUPONS

(71) Applicant: MasterCard International Incorporated, Purchase, NY (US)

(72) Inventors: Lukas EKSELIUS, Overijse (BE); Sebastien POCHIC, Schaerbeek (BE); Fikret ATES, Namur (BE)

(73) Assignee: MASTERCARD INTERNATIONAL INCORPORATED, Purchase, NY (US)

(21) Appl. No.: 14/332,858

(22) Filed: Jul. 16, 2014

(51) Int. Cl. G06Q 30/02

(52) U.S. Cl. CPC G06Q 30/0211

(57) ABSTRACT

A method for efficiently distributing coupons to consumers including, inter alia, storing a plurality of consumer profiles; receiving, from a first device of a first consumer, a first consumer identifier associated with the first consumer and identification of at least one second consumer to whom a coupon, with an associated coupon identifier, is to be forwarded; forwarding the coupon to a second device of the at least one second consumer; creating a coupon forwarding data entry, in a consumer profile of the first consumer; receiving a notification indicating coupon redemption and including at least the coupon identifier; updating a consumer profile of the second consumer to reflect a weighted interest level; identifying from the first database, coupon history information that includes at least forwarding and redemption information associated with the redeemed coupon; and generating statistics based on the identified coupon history information.

### FIELD

The present disclosure relates to the efficient distribution of coupons to consumers and, more specifically, to the rewarding of consumers for efficiently forwarding coupons to appropriate individuals and to the utilization of coupon redemption and forwarding characteristics to generate statistics for efficiency reporting.

### BACKGROUND

Merchants, manufacturers, retailers, restaurants, advertising companies, and other entities advertise in a variety of ways in order to reach consumers and provide incentives for consumers to patron their establishments. For example, such entities (herein referred to as “merchants”, though not limited to this example) may advertise via television, radio, newspapers, magazines, and Internet and may further utilize coupons (e.g., offers, deals, discounts, etc.) in order to increase business traffic. Coupons may offer consumers an incentive for patronizing a merchant such as discounts for products (e.g., goods and/or services) to encourage the consumer to not only purchase the discounted products, but perhaps additional items.

However, the distribution of coupons to consumers may be costly for many merchants, advertising companies, or other entities in time, expense and resources. By distributing coupons only to those consumers likely to redeem them, merchants may minimize the expenses incurred for the production and distribution of coupons while maximizing the return from the coupons. However, to do so, the merchant must have prior knowledge of those consumers with a propensity to redeem certain coupons. Moreover, for budgeting and other purposes, many merchants, advertising companies, or other coupon providers would prefer to know the likelihood that certain coupons will be redeemed before distributing those coupons to consumers. It would be also preferable to distribute coupons to consumers with knowledge that distributed coupons may be referred to applicable consumers and subsequently redeemed in an efficient manner.

Some methods and systems have been developed that attempt to use coupon redemption history in addition to other data to generate a behavioral profile of the consumer, such as the methods and systems described in (1) U.S. patent application Ser. No. 13/293,870, entitled “Method and Apparatus for Distributing Advertisements Using Social Networks and Financial Transaction Card Networks” by Peter D. Kaulbach et al., filed on Nov. 10, 2011 and (2) U.S. patent application Ser. No. 14/261,598, entitled “Method and System for Predicting Coupon Redemption” by Jason Feldman, filed on Apr. 25, 2014, which are each incorporated herein by reference in their entirety. However, such systems may receive redemption data secondhand and may rely upon themselves entirely for the proper identification and distribution of coupons to appropriate consumers.

Thus, a need exists to solve the technical problem of effective distribution, tracking of referrals and redemption in a manner that provides a technical solution for these problems as well as enhancing consumer profiles, and redemption statistics. This is achieved by a method and system for efficiently distributing coupons to consumers that does not rely entirely upon targeted advertising. More specifically, there is a need for a technical solution to improve the distribution of coupons to consumers in an effort to achieve a higher rate of redemption by providing rewards to consumers as an incentive to forward coupons to applicable consumers. A need also exists for the analysis of history information on redeemed coupons and the generation of statistics to be utilized by a various parties (e.g., merchants, advertising companies, coupon providers, etc.).

### SUMMARY

Systems and methods for efficient distribution of coupons to consumers are disclosed herein.

Some exemplary embodiments of the present disclosure involve a method for efficiently distributing coupons to consumers and rewarding consumers for coupon redemption. Such a method includes storing, in a first database of a financial system, a plurality of consumer profiles, wherein each consumer profile is associated with a consumer identifier, and receiving, by a receiving device, from a first mobile device of a first consumer, (i) a first consumer identifier associated with the first consumer and (ii) identification of at least one second consumer to whom a coupon, with an associated coupon identifier, is to be forwarded. The method further includes forwarding, by a processing device, the coupon to a second mobile device of the at least one second consumer, and creating, by the processing device, a coupon forwarding data entry, which includes (i) the coupon identifier and (ii) a number corresponding to the number consumers to whom the coupon was forwarded prior to redemption is created, in the first database, in a consumer profile of the first consumer. The receiving device receives a notification indicating redemption of the coupon by a second consumer and that includes at least the coupon identifier. A consumer profile of the second consumer, in the first database, is then updated to reflect a weighted interest level pertaining to at least one of a coupon category, coupon type, product category, merchant category, merchant and manufacturer associated with the redeemed coupon. The coupon identifier is then used to identify, in the first database, coupon history information, which includes at least forwarding information and redemption information associated with the redeemed coupon and generates statistics on a basis of the identified coupon history information.

Other exemplary embodiments of the present disclosure involve a method for efficiently distributing coupons to consumers and rewarding consumers for coupon redemption, which includes storing, in a first database, a plurality of consumer profiles, wherein each consumer profile includes information related to a consumer. Such a method also includes receiving, by a receiving device, a notification of coupon redemption that includes at least a coupon identifier associated with a redeemed coupon. The first database is updated to include information regarding the redemption of the coupon such that the redemption information is associated with (1) a first consumer profile of a first consumer who obtained and forwarded the coupon and (2) a second consumer profile of a second consumer associated with the payment transaction and who redeemed the coupon. The second consumer profile in the first database is updated to reflect a weighted interest level pertaining to at least one of a coupon category, coupon type, product category, merchant category, merchant and manufacturer associated with the redeemed coupon. A processing device then identifies coupon history information, using the coupon identifier, that includes at least forwarding information and redemption information associated with the redeemed coupon. The method further includes storing, in a second database, the coupon history information, and generating, by the processing device, statistics on a basis of the stored coupon history information.

Further exemplary embodiments of the present disclosure involve a system for efficiently distributing coupons to consumers and rewarding consumers upon coupon redemption, that includes a first database, a receiving device, and a processing device. The first database is configured to store a plurality of consumer profiles, wherein each consumer profile is associated with a consumer identifier. The receiving device is configured to receive from a first mobile device of a first consumer, (i) a first consumer identifier associated with the first consumer and (ii) identification of at least one second consumer to whom a coupon, with an associated coupon identifier, is to be forwarded. The processing device may (i) forward the coupon to the at least one second consumer, (ii) create a coupon forwarding data entry in a consumer profile of the first consumer, wherein the coupon forwarding data entry includes the coupon identifier and a number corresponding to the number of consumers to whom the coupon was forwarded prior to redemption of said coupon. Upon redemption of the coupon by a second consumer, the processing device is further configured to (i) update a consumer profile of the second consumer to reflect a weighted interest level pertaining to at least one of a coupon category, coupon type, product category, merchant category, merchant and manufacturer associated with the redeemed coupon, (ii) identify from the first database, using the coupon identifier, coupon history information, wherein the coupon history information includes at least forwarding information and redemption information associated with the redeemed coupon, (iii) and generate statistics on a basis of the stored coupon history information.

Additional exemplary embodiments of the present disclosure involve a system for efficiently distributing coupons to consumers and rewarding consumers for coupon redemption, which includes a first database, a receiving device and a processing device. The first database is configured to store a plurality of consumer profiles, wherein each consumer profile is associated with a consumer identifier. The receiving device is configured to receive from a first mobile device of a first consumer, (i) a first consumer identifier associated with the first consumer and (ii) identification of at least one second consumer to whom a coupon, with an associated coupon identifier, is to be forwarded. The processing device configured to (i) forward the coupon to the at least one second consumer, (ii) create a coupon forwarding data entry in a consumer profile of the first consumer, wherein said coupon forwarding data entry includes the coupon identifier and a number corresponding to the number of consumers to whom the coupon was forwarded prior to redemption of said coupon. Upon redemption of the coupon by a second consumer, the processing device is further configured to (i) update a consumer profile of the second consumer to reflect a weighted interest level pertaining to at least one of a coupon category, coupon type, product category, merchant category, merchant and manufacturer associated with the redeemed coupon; (ii) identify from the first database, using the coupon identifier, coupon history information, wherein the coupon history information includes at least forwarding information and redemption information associated with the redeemed coupon; and (iii) generating statistics on a basis of the stored coupon history information.

### BRIEF DESCRIPTION OF THE DRAWING FIGURES

The exemplary embodiments of the disclosed systems and methods can be better understood with reference to the following drawings and description. The components in the figures are not necessarily to scale, emphasis instead being placed upon illustrating the principles of exemplary embodiments of the disclosed systems and methods. Moreover, in the figures, like elements are described with like reference numbers.

FIG. 1 is a high level architecture illustrating a system that efficiently distributes coupons to consumers in accordance with exemplary embodiments.

FIG. 2 is a block diagram illustrating the processing server of the system of FIG. 1 in accordance with exemplary embodiments.

FIG. 3 is a block diagram illustrating a first database of the processing server of FIG. 2 for the storage of consumer profiles in accordance with exemplary embodiments.

FIG. 4 is a block diagram illustrating a second database of the processing server of FIG. 2 for the storage of coupon profiles in accordance with exemplary embodiments.

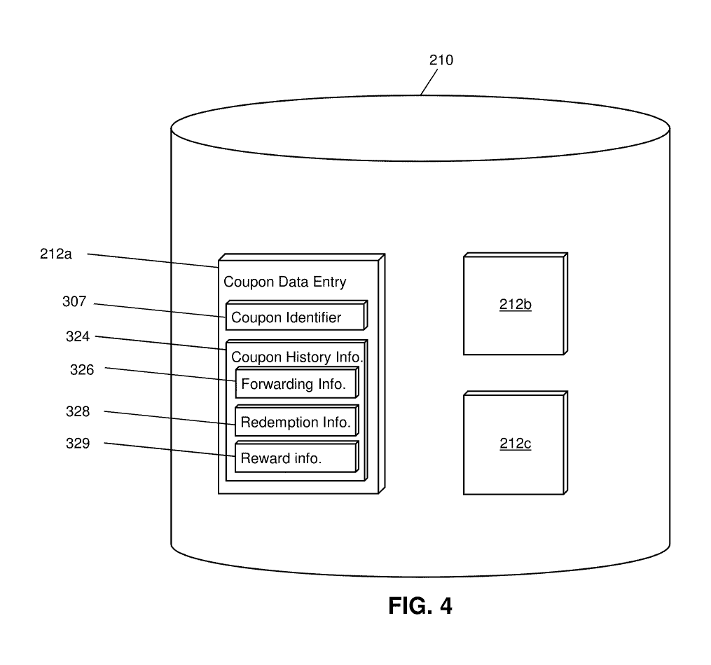

FIG. 5 is flow diagram illustrating a process for the receipt and identification of coupon data for a redeemed coupon when a consumer transacts with a merchant using a payment transaction card, as a payment instrument, in accordance with exemplary embodiments.

FIG. 6 is a flow diagram illustrating a process for the receipt and identification of coupon data for a redeemed coupon when a consumer transacts with a merchant using cash as a payment instrument in accordance with exemplary embodiments.

FIG. 7 is flow chart illustrating an exemplary method for the efficient distribution of coupons to consumers in accordance with exemplary embodiments.

FIG. 8 is a flow chart illustrating an exemplary method for the efficient distribution of coupons to consumers in accordance with exemplary embodiments.

FIGS. 9a and 9b illustrate an example of computing devices displaying received and forwarded coupons and encoded identifiers for identifying the coupon and users who have received and forwarded the coupon.

FIG. 10 is a block diagram illustrating a computer system architecture in accordance with exemplary embodiments.

Further areas of applicability of the present disclosure will become apparent from the detailed description provided hereinafter. It should be understood that the detailed description and exemplary embodiments are intended for purposes of illustration only and that the claimed invention is not limited to these particular embodiments but rather fully encompasses variations and modifications which may occur to those skilled in the art.

### DETAILED DESCRIPTION OF THE DRAWINGS

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

User—A user includes any entity making purchases of goods and/or services. As used herein, the term “user”, “customer”, “consumer”, “account holder”, “cardholder”, and “card user” can be used interchangeably. Unless specifically stated differently or from context, a user may be interchangeably used herein to identify a human customer, a software application, or a group of customers and/or software applications executed by one or more consumers to conduct a purchase transaction.

Computing Device—A computing device is any device including a processor that may be used in the receiving and forwarding of offers. As used herein, the term “computing device”, “device”, “mobile device”, and “mobile phone” can be used interchangeably.

Third Party—An entity that is not directly involved in a transaction. A third party may include, for example, a merchant, a retailer, a wholesaler, a manufacturer, advertising agency, demographic tracking agency, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for the Identification of Coupon Redemption Characteristics

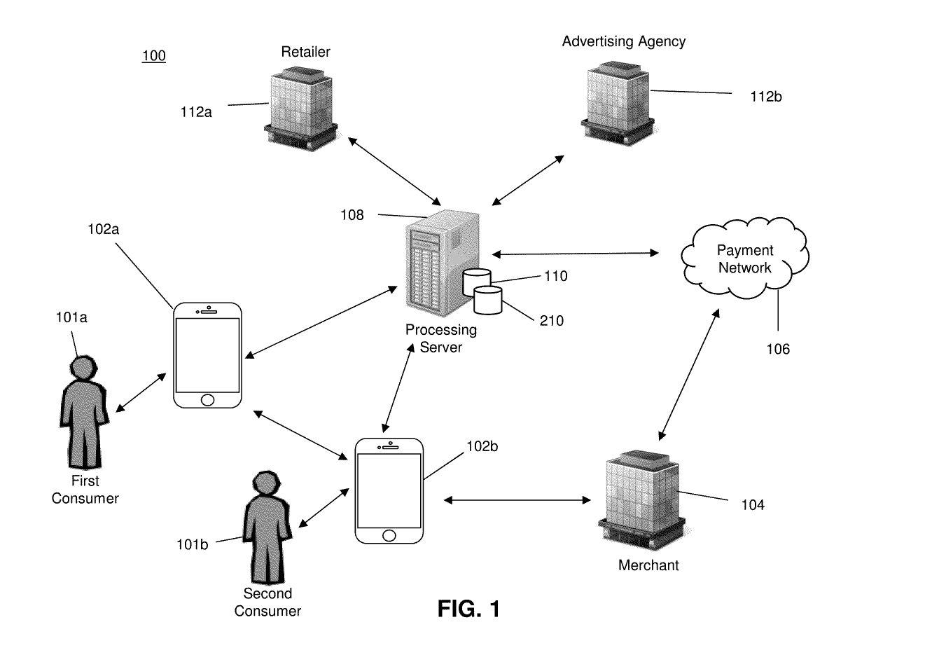

FIG. 1 illustrates a system 100 for the efficient distribution of coupons to consumers and the rewarding of consumers upon coupon redemption.

The system 100 includes a plurality of consumers, a merchant 104, a payment network 106, a processing server 108, and at least one third party. The plurality of consumers may include, for example, a first consumer 101a and a second consumer 101b who may be in possession of or be otherwise associated with a coupon and may use the coupon during a payment transaction with the merchant 104, such as for the purchase of discounted goods and/or services from the merchant 104. First consumer 101a is associated with a first computing device 102a (herein referred to as “device 102a” or “first device 102a”). The device 102a of the first consumer 101a is configured to communicate with at least the processing server 108 and a second computing device 102b associated with consumer 101b and to receive, redeem and forward coupons. Although not depicted, the device 102a of the first consumer 101a may also be configured to communicate with the merchant 104 (e.g., in an attempted transaction initiated by the first consumer 101a via his/her device 102a). Second consumer 101b is associated with a second computing device 102b (herein referred to as “device 102b” or “second device 102b). The device 102b of the second consumer 101b is configured to communicate with at least the merchant 104 and the device 102a of the first consumer 101a. The device 102b of the second consumer 101b is further configured to receive, redeem and forward coupons. In some embodiments, the device 102b of the second consumer 101b may also be configured to communicate with the processing server 108.

The merchant 104, and/or an acquirer (not depicted) associated with the merchant 104, is configured to interact with a consumer (for example, second consumer 101b) and the payment network 106. For example, when the consumer initiates a purchase of goods and/or services offered by the merchant 104 and utilizes money in the physical form of currency (e.g., dollar bills, coins, etc.), herein referred to as “cash”, and further presents a coupon (e.g., to discount the goods and/or services), the merchant may transmit a notification of coupon redemption to the payment network 106 for processing. Conversely, when the consumer (e.g., second consumer 101b) initiates the purchase of goods and/or services offered by the merchant 104 and utilizes a payment card (e.g., credit card, debit card, etc.) as the payment instrument, the merchant may submit an authorization request for the payment transaction to the payment network 106 for processing. The authorization request may include transaction data (e.g., a transaction amount, time and/or date, geographic location, product data, etc.) and a consumer identifier (e.g., an account identifier corresponding to a payment account associated with the consumer used to fund the transaction, which can be the account number or a separate alphanumeric identifier linked or otherwise associated with the consumer, particularly when there are multiple consumers associated with a payment account). If a coupon is presented to the merchant 104 and redeemed by the consumer, the authorization request would further include a coupon identifier (discussed in more detail herein) corresponding to the coupon presented and redeemed by the consumer.

The payment network 106, if a payment card is utilized as the payment instrument in the purchase of goods and/or services, may process a payment transaction using methods and systems that will be apparent to persons having skill in the relevant art. In some embodiments, the payment network 106 may process the redemption of the coupon instead of the merchant 104 and may then process the payment transaction using traditional methods. The payment network 106 may also transmit a copy of the authorization request, or at least a portion of the data contained therein, to the processing server 108.

The processing server 108 is configured communicate with at least a first consumer 101a, a second consumer 101b, a merchant 104 and at least one third party (e.g., retailer 112a, advertising agency 112b, coupon provider, etc.). In some embodiments, the processing server 108 is configured to distribute coupons to a plurality of users. Such distribution may be based on user's purchasing history or may be a broadcast distribution (e.g., sent to a plurality of users regardless of purchasing history). The processing server 108 is further configured to receive information from the first device 102a of the first consumer 101a regarding a coupon (with an associated coupon identifier), which the first consumer 101a would like to forward to at least one second consumer (e.g., second consumer 102b). Such information may include, for example, a first consumer identifier associated with the first consumer 101a and identification (e.g., an identifier, name, etc.) of at least one second consumer (e.g., second consumer 101b) to whom the first consumer 101a would like to forward the coupon.

In some embodiments, the information may further include the coupon itself. For example, the first consumer 101a may have received a coupon via e-mail (e.g., distributed to the first consumer 101a by a coupon provider or advertising agency), through social media (e.g., via Facebook), etc. and may send the coupon to the processing server 108 to store therein and to forward to the second consumer 101b.

In other embodiments, the information may further include the coupon identifier (associated with the coupon), which uniquely identifies the coupon. For example, a coupon identifier may be a unique value associated with the corresponding coupon that may be used for identification. Values that may be used as the coupon identifier may include identification numbers, universal product codes, stock-keeping units, and other suitable values as will be apparent to persons having skill in the relevant art. In such embodiments, the processing server 108 may have provided the coupon to the first consumer 101a and, therefore, may already have a record of the coupon. In such embodiments, the processing server 108 is configured to use the received coupon identifier to either (i) locate a stored coupon (associated with the received coupon identifier) and to forward the stored coupon to the second consumer 101b or (ii) request associated coupon data from, e.g., a coupon provider (not depicted), such as by providing the coupon identifier in a request for identification of the corresponding coupon data.

Upon redemption of the coupon (e.g., by the second consumer 101b) at the merchant 104, the processing server 108 is configured to receive a notification from the merchant 104, via the payment network 106. Such a notification may include, for example, at least one consumer identifier and the coupon identifier associated coupon data of the redeemed coupon. The notification (including the at least one consumer identifier and the coupon identifier) may be included in an authorization request from the merchant 104, if the consumer uses a transaction card as the payment instrument.

In some embodiments, the processing server 108 may request the coupon data associated with the redeemed coupon from a coupon database (discussed in more detail herein). The coupon database may be a component of the processing server 108 or may be external to the processing server (e.g., a component of the coupon provider (not depicted)). If requesting coupon data from a coupon database of a coupon provider, the processing server 108 may provide the coupon identifier in a request for identification of the corresponding coupon data. In other embodiments, the authorization request may include the coupon data corresponding to the redeemed coupon (e.g., read and/or obtained by the merchant 104 when the coupon is redeemed).

The coupon data may include any data corresponding to the coupon that is suitable for use in performing the functions as discussed herein as will be apparent to persons having skill in the relevant art, such as coupon type, coupon category, coupon amount, transaction modifier, coupon value, merchant data, manufacturer data, product data, start date, expiration date, quantity, time and/or date of redemption, and restrictions or limits on redemption.

As discussed in more detail herein, upon redemption of the coupon, the processing server 108 is further configured to notify the first consumer 101a of redemption of the offer (e.g., through the first device 102a of the first consumer 101a), identify at least one consumer profile, which is stored in a consumer database 110, and to identify a coupon data entry, which is stored in a coupon database 210.

When notifying the first consumer 101a of redemption of the offer, such a notification may include a reward (e.g., such as points) for the first consumer 101a for the appropriate forwarding and subsequent redemption of the coupon. Points may be used for, e.g., purchasing goods and/or services, receiving future, more advantageous offers, or receiving a cash reward. In some embodiments, the processing server 108 may provide a plurality of rewards from which the first consumer 101a may select. In one embodiment, there is a direct relationship between the value of the reward and to how many second consumers the coupon has been forwarded. For example, the value of the reward increases with increasing number of forwards. Thus, the value of the reward would be larger when the first consumer 101a forwards the coupon to a large number of second consumers as opposed to when the first consumer 101a forwards the coupon to a small number of consumers. In some embodiments, the second consumer 101b, to whom the coupon was forwarded, may also receive an incentive upon redemption of the offer.

The processing server 108 is configured to create and update data entries in the identified profiles of the consumer database 110 and the coupon database 210 (discussed in more detail herein) and to utilize data stored in both the consumer database 110 and the coupon database 210 to generate statistics including information on redeemed coupons. Such information can include, for example, a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc.

The processing server 108 is further configured to receive requests for statistics (including information on redeemed coupons) from a third party (e.g., retailer 112a, advertising agency 112b, etc.). Such a request may include, for example, information regarding a coupon category, a coupon type, a product category, a merchant category, a merchant, a manufacturer, and/or a type of reward. The processing server 108 may then generate statistics, for the third party, based on the information provided in the request and using information on redeemed coupons stored in the coupon database 210. Such generated statistics (e.g., a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc.) may then be utilized by the third party for the identification of (i) future coupons most likely to be redeemed by consumers, (ii) rewards that are most likely to incentivize consumers to forward coupons to appropriate individuals, etc.

### Processing Server

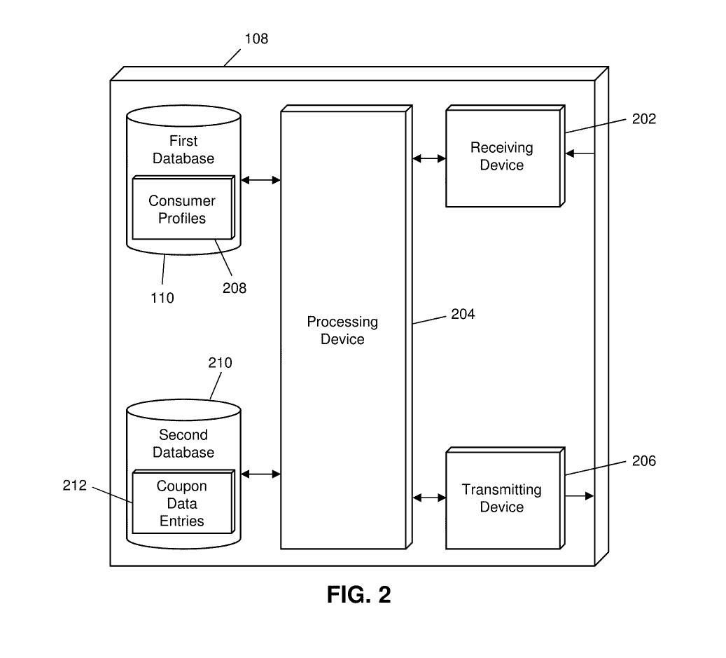

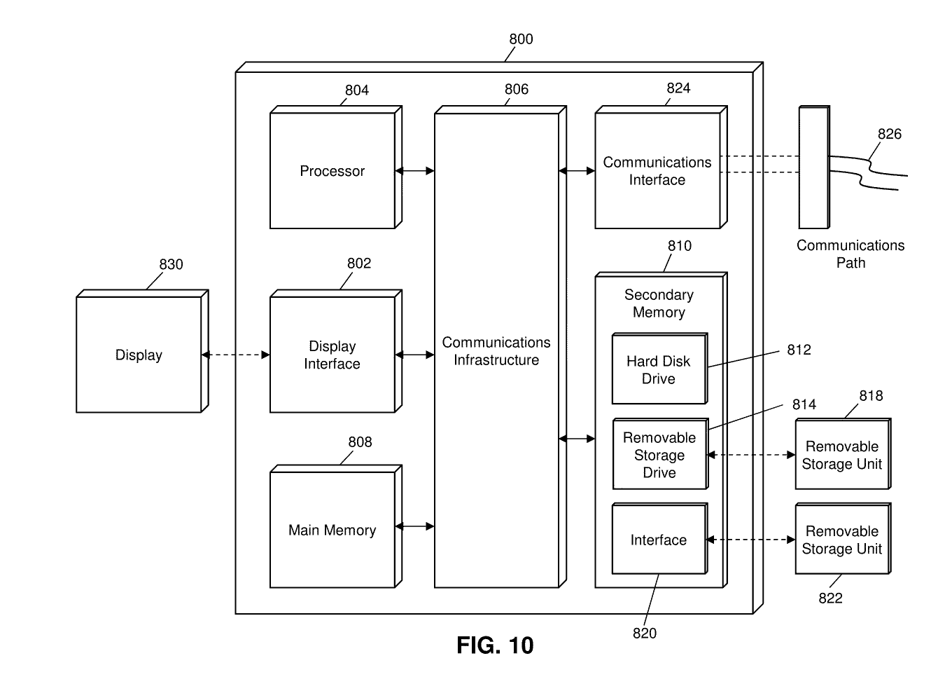

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 10 and discussed in more detail below may be a suitable configuration of the processing server 108.

The processing server 108 includes a receiving device 202, a processing device 204, a transmitting device 206, a consumer database 110 (also referred to herein as “first database”), and a coupon database 210 (also referred to herein as “second database”).

The receiving device 202 is configured to receive data over one or more networks via one or more network protocols. In some embodiments, the receiving device 202 is configured to receive information from the first device 102a of the first consumer 101a. Such information may include a first consumer identifier that is associated with the first consumer 101a, a coupon identifier associated with a coupon, a coupon itself, and identification of at least one second consumer (e.g., second consumer 101b) to whom a coupon is to be forwarded.

In some embodiments (when a transaction card is used as the payment instrument), the receiving device 202 is configured to receive an authorization request from the merchant 104 (for an attempted transaction) via the payment network 106 including at least the coupon identifier (e.g., when the coupon has been redeemed at the merchant). The authorization request, in some embodiments, may also include a consumer identifier. In other embodiments (e.g., when cash is used as the payment instrument and when the coupon has been redeemed at the merchant), the receiving device 202 is configured to receive a notification from the merchant 104 (e.g., via the payment network 106 or other communication channel) indicating coupon redemption and including at least the coupon identifier. Such a notification may also include at least one consumer identifier.

The receiving device 202 is further configured to receive a request for statistics from a third party (e.g., retailer 112a, advertising agency 112b, etc.). Such a request may include, for example, information regarding a coupon category, a coupon type, a product category, a merchant category, a merchant, a manufacturer, and/or a type of reward.

In yet other embodiments, the receiving device 202 is configured to receive coupon data from a third party (e.g., retailer 112a, advertising agency 112b, a coupon distributor) and to further receive coupons themselves, from the third party, for distribution to a plurality of consumers on behalf of the third party.

The processing device 204 of the processing server 108, in some embodiments, is configured to distribute coupons (via transmitting device 206) to a plurality of users. Such coupons may have been received from a third party (e.g., retailer 112a, advertising agency 112b, a coupon distributor), and the distribution thereof may be based on users' purchasing history or may be a blind distribution (e.g., sent to a plurality of users regardless of purchasing history). The processing device 204 is also configured to forward (via the transmitting device 206) a coupon received from a first device 102a of a first consumer 101a to a second device 102b of a second consumer 101b. The processing device 204 is further configured to identify a consumer profile(s) 208 stored the consumer database 110 based on either a consumer identifier (e.g., included in an authorization request received from a merchant 104 or a coupon redemption notification) or a coupon identifier of a redeemed coupon. In some embodiments, the identified consumer profile 208, discussed in more detail below, is associated with the second consumer 101b involved in the payment transaction and who redeemed the coupon. In other embodiments, the identified consumer profile 208 is associated with the first consumer 101a who forwarded the coupon to the second consumer 101b. In yet other embodiments, the identified consumer profile(s) 208 include both the first consumer 101a and the second consumer 101b.

The processing device 204 may be further configured to identify coupon data corresponding to the coupon redeemed in the payment transaction via the coupon identifier included in a received redemption notification or in a received authorization request. As previously discussed, the coupon identifier may be a unique value associated with the corresponding coupon that may be used for identification. Values that may be used as the coupon identifier may include identification numbers, universal product codes, stock-keeping units, and other suitable values as will be apparent to persons having skill in the relevant art.

In one embodiment, the coupon data may be included in the authorization request or redemption notification (received by the receiving device). In another embodiment, the coupon data may be received (by the receiving device 202) from a coupon provider upon request.

The processing device 204 is also configured to create and update data entries in the identified consumer profiles of the consumer database 110 and the coupon database 210 (discussed in more detail herein) and to utilize data stored in both the consumer database 110 and the coupon database 210 to generate statistics (e.g., upon a request from a third party) including information on redeemed coupons. Such information can include, for example, a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc.

Upon redemption of a coupon, the processing device 204 is further configured to determine an appropriate reward for the successful forwarding and subsequent redemption of a coupon and to notify the first consumer 101a (via the first device 102a of the first consumer 101a), with whom the coupon originated and who forwarded (e.g. referred) the coupon, that the coupon was redeemed. In some embodiments the redemption notification includes the reward. The reward may be (e.g., as determined by the processing device 204) points of whatever type, which may be used for, e.g., purchasing goods and/or services, receiving future (more advantageous coupons), or receiving a cash reward.

As discussed herein, the first consumer 101a may forward the coupon to a plurality of consumers, including the second consumer 101b who ultimately redeems the coupon. The processing device 204 determines the reward, to be presented to the first consumer 101a, for the forwarding and subsequent redemption of the coupon. In some embodiments, if the first consumer 101a forwards the coupon to a large number of second consumers, the processing device 204 may determine that the value of the reward should be increased. Conversely, if the first consumer 101a forwards the coupon to a small number of second consumers, the processing device 204 may decrease the value of the reward. In other embodiments, the processing device 204 may be configured to increase the value of a reward if coupon redemption (e.g., by the second consumer 101b) occurs in a short amount of time after having been forwarded (e.g., by the first consumer 101b). Conversely the processing device 204 may be configured to decrease the value of a reward if coupon redemption occurs beyond a predetermined length of time. In yet other embodiments, the processing device 204 may determine that the first consumer 101a is eligible to select from a plurality of different rewards. In some embodiments, the second consumer 101b, to whom the coupon was forwarded, may also receive an incentive upon redemption of the offer.

In each of the above-described embodiments, the first consumer 101a may immediately redeem a single reward or may accumulate a plurality of rewards for future redemption.

The transmitting unit 206 of the processing server 108 is configured to transmit data over one or more networks via one or more network protocols. In some embodiments, the transmitting unit 206 may distribute a coupon (or coupons) to a plurality of consumers. In other embodiments, the transmitting unit 206 may forward a coupon (received by the receiving device 202 from the first consumer 101a) to the second consumer 101b. The transmitting unit 206 is also configured to transmit a request (including a coupon identifier) for coupon data to the third party (e.g., retainer 112a, advertising agency 112b, coupon provider, etc.). The transmitting unit 206 is further configured to transmit a reward (or rewards), as determined by the processing device 204) to the first device 102a of the first consumer 101a, upon redemption of a coupon.

The consumer database 110 of the processing server 108 (discussed in more detail herein) is configured to store a plurality of consumer profiles 208 (208a, 208b, 208c). Each consumer profile is associated with a respective consumer and is identified by a unique consumer identifier. The consumer database 110 is configured to be updated (e.g., by the processing device 204) upon the forwarding and redemption of coupons. In some embodiments, new data entries are created in at least one of the consumer profiles (e.g., by the processing device 204) to reflect coupon data associated with a coupon that was forwarded and/or received.

The coupon database 210 of the processing server 108 (discussed in more detail herein) is configured to store a plurality of coupon data entries 212. Each coupon data entry 212 may include data related to a coupon including a coupon identifier, coupon data, etc. The coupon database, and coupon data entries stored therein, are configured to be created and/or updated (e.g., by the processing device 204) at least upon receiving coupon data, upon the forwarding of a coupon, and upon the redemption of the coupon.

### Consumer Database

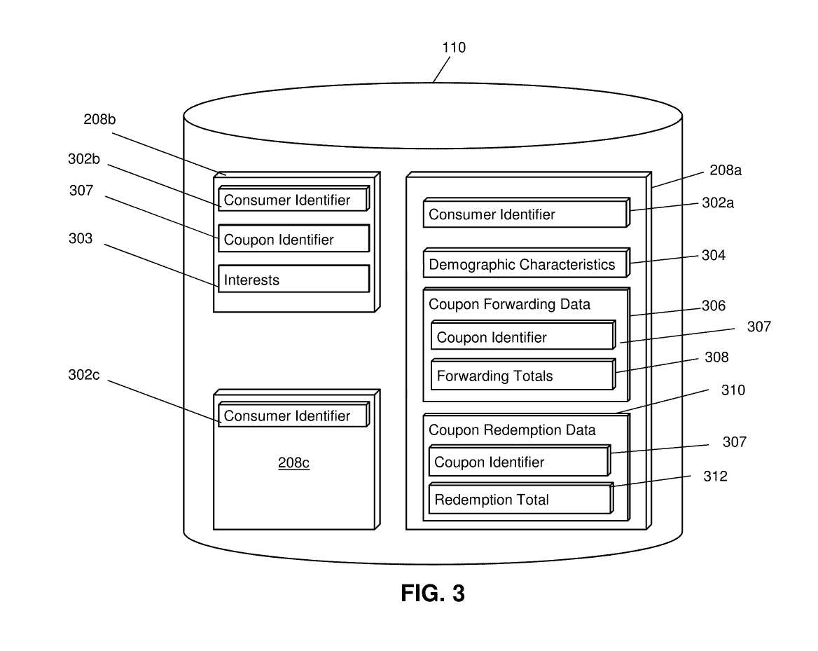

FIG. 3 illustrates the consumer database 110 stored in the processing server 108. As discussed above, the consumer database 110 is configured to store a plurality of consumer profiles 208 (208a, 208b, 208c) that are each associated with a respective consumer. For example, as depicted in FIG. 3, the consumer database 110 includes at least a first consumer profile 208a associated with first consumer 101a, a second consumer profile 208b associated with second consumer 101b, and a third consumer profile 208c associated with a third consumer (not depicted). Moreover, each consumer profile 208a, 208b, 208c is identified by a respective unique consumer identifier 302 (302a, 302b, 302c). The consumer identifier 302 (302a, 302b, 302c) may be a unique value suitable for the identification of a consumer corresponding to the respective consumer profile 208 (208a, 208b, 208c). The consumer identifier 302 may be an identification number, a payment account number corresponding to a payment account associated with the consumer, a phone number, an e-mail address, a street address, a name, combinations thereof or any other suitable value that may be unique to a consumer whether known by name or anonymous, as will be apparent to persons having skill in the relevant art.

Each consumer profile 208 (208a, 208b, 208c) may also include coupon forwarding data 306 and coupon redemption data 310. In some embodiments, each consumer profile 208 may further include demographic characteristics 304.

The consumer databases 208 (208a, 208b, 208c) are configured to be updated (e.g., by the processing device 204) upon the forwarding and redemption of coupons. For example, the first consumer 101a may forward a coupon to a plurality of second consumers. In some embodiments, the first consumer 101a may provide either a coupon identifier or a coupon itself to the processing device 204 and request the processing device 204 forward the coupon to at least the second consumer 101b. In such an embodiment, the consumer profile 208a, associated with the first consumer 101a, is updated (by the processing device 204) to reflect the forwarding information. For example, coupon forwarding data entry 306 may be created and/or updated, by the processing device 204 in the consumer profile 208a of the first consumer 101a. Such a coupon forwarding data entry 306 may include, for example, the coupon identifier 307, a date of original forward (by the first consumer 101a), and a number associated with the number of people to whom the first consumer 101a forwarded the coupon. For example, if the first consumer 101a requested the processing device 204 forward the coupon to 100 people, the forwarding total 308 would be 100. In some embodiments, the forwarding total 308 may also reflect subsequent forwards by any of the second consumers.

A consumer profile 208b associated with the second consumer 101b may also be updated to reflect that the coupon was forwarded to the second consumer 101b. For example, upon the processing device 204 forwarding the coupon to the second consumer 101b, the consumer profile 208b associated with the second consumer 101b may be updated with the coupon identifier 307 associated with coupon.

Upon redemption of the coupon, e.g., by the second consumer 101b, the consumer profiles of the first consumer 101a and the second consumer 101b may also be updated. For example, the consumer profile 208a of the first consumer 101a may be updated to include coupon redemption data 310. The coupon redemption data 310 may include information regarding coupons that the first consumer 101a previously forwarded, which have been redeemed (e.g., by the second consumer 101b). For example, a coupon redemption data 310 entry may be created, by the processing device in the first consumer database 208a associated with the first consumer 101a. Such a coupon redemption data entry 310 may include the coupon identifier 307 indicating that the associated coupon had been redeemed. In some embodiments, the first consumer profile 208a associated with the first consumer 101a may also be updated to include a redemption total 312. The redemption total 312 is a number associated with the number of people who have redeemed the forwarded coupon. For example, if the first consumer 101a requested the processing device 204 forward the coupon to 100 people, the forwarding total 308 would be 100. However, if only 5 of those 100 people actually redeemed the coupon, the redemption total 312 would be 5. In some embodiments, if any of the second consumers (to whom the first consumer 101a initially forwarded the coupon) subsequently forwards the coupon to a plurality of third consumers, and if any of those third consumers redeems the coupon, the redemption total 312 may also reflect such redemptions.

In some embodiments, the coupon redemption data 310 may also include dates of redemption (e.g., by the second consumer 101b and by other consumers to whom the coupon was forwarded), time or redemption, product data corresponding to one or more products purchased (e.g., at a discount) using the redeemed coupon. The product data may include a universal product code, stock-keeping unit, serial number, manufacturer part number, international standard book number, product category, manufacturer, purchase amount, color, or other applicable product data as will be apparent to persons having skill in the relevant art.

In yet other embodiments, the coupon redemption data 310 may include a coupon category, coupon type, coupon value, product category, merchant category, merchant, manufacturer, start date, expiration date, quantity, date of redemption, time of redemption, transaction amount at time of redemption, one or more limits or restrictions on redemption, or other suitable information.

Based on the coupon forwarding data 306 and the coupon redemption data 310, coupon history information 324 may then be stored in the coupon database 210, as discussed in more detail herein.

The consumer database 208b of the second consumer 101b is also configured to be updated upon redemption of the coupon by the second consumer 101b. For example, an interest entry 303 may be created that reflects a weighted interest level of the second consumer 101b regarding one or more criteria including a coupon category, type of coupon, product category merchant category, merchant and/or manufacturer associated with the redeemed coupon. Said another way, the interest entry 303 may identify a propensity for the second consumer 101b to redeem a coupon based one or more of the above-listed criteria. Additional criteria and/or characteristics that may be identified by the processing unit 204 based on redeemed coupon data will be apparent to persons having skill in the relevant art.

In some embodiments, rather than the first consumer 101a requesting the processing device 204 to forward a coupon to a plurality of second consumers, the first consumer 101a may forward the coupon directly to the plurality of second consumers. For example, the first device 102a of the first consumer 101a may receive a coupon, e.g., from the processing server 108 or a third party (e.g., retailer 112a, advertising agency 112b, coupon distributor, etc.). The first consumer 101a may or may not be interested in the coupon, but decides that he/she would like to forward the coupon. The first consumer 101a may forward the consumer to only one second consumer (e.g., the second consumer 101b). For example, the first consumer 101a may e-mail the coupon to at least the second consumer 101b. In another example, the first consumer 101a may use a form of social media (e.g., Facebook, Twitter, etc.) to forward the coupon to at least the second consumer 101b.

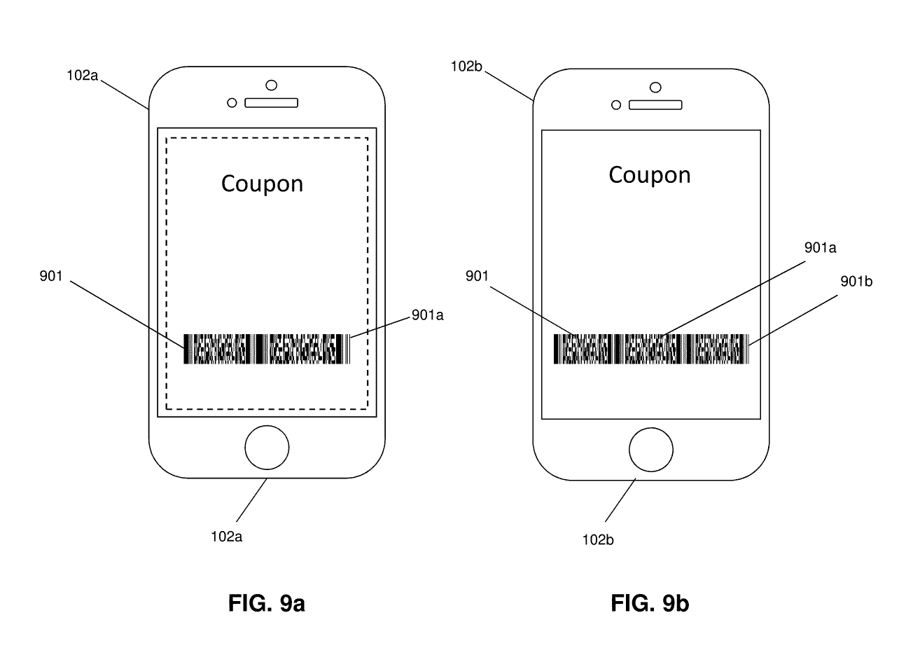

In such an embodiment, since the first device 102a of the first consumer 101a directly forwards the coupon to at least the second consumer 101b, the processing server 108 may not be aware of the forwarding. Thus, the offer may be encoded (e.g., marked) with a unique identifier corresponding to the first consumer 101a of the first device 102a. The encoded unique identifier may be bar code, a QR code or nearly any other optically machine readable code. In some embodiments, the encoding may be done upon distribution of the offer (e.g., by the processing server 108 or the third party). In other embodiments, the encoding may be done at the first device 102a of the first consumer 101a upon receiving the offer. Such encoding of the offer is illustrated, for example, in FIG. 9a. FIG. 9a illustrates a received coupon displayed on a display screen of the first device 102a of the first consumer 101a. The coupon includes a coupon title (e.g., “coupon”), an encoded coupon identifier 901 and the encoded unique identifier 901a of the first consumer 101a. If the coupon is forwarded from the first device 102a of the first consumer 101a to the second device 102b of the second consumer 101b, the coupon may be further encoded with a second unique identifier 901b corresponding to the second consumer 101b of the second device 102b. FIG. 9b illustrates a forwarded coupon displayed on a display screen of the second device 102b of the second consumer 101b. The forwarded coupon includes the coupon title (“coupon”), the encoded coupon identifier 901, the encoded unique identifier 901a of the first consumer 101a, and the encoded unique identifier 901b of the second consumer 101b. If the coupon is forwarded continuously, additional unique identifiers may be further encoded on the offer.

When the coupon is redeemed, the encoded coupon identifier is read, e.g., by the merchant, and the notification of redemption transmitted to the processing server 108 (e.g., by the merchant). The notification may include the encoded coupon identifier as well as any encoded unique identifiers (associated with consumers). The encoded coupon identifier as well as any encoded unique identifiers may be decoded, e.g., by the processing server 108 so that the consumer databases can be updated and that the redemption and subsequent redemption can be properly attributed to the first consumer 101a (who originally forwarded the coupon). For example, the unique identifiers associated with the first and second consumers (when decoded) may match the consumer identifiers of the first and second consumers 101a, 101b that are associated with the first and second consumer profiles 208a, 208b of the first and second consumers 101a, 101b.

Additional information regarding the encoding and decoding of unique identifiers may be found in U.S. patent application Ser. No. 13/292,870, entitled “Method and Apparatus for Distributing Advertisements Using Social Networks and Financial Transaction Card Networks” by Anna Zanghi and Peter Kaulbach filed on Nov. 10, 2011, which is herein incorporated by reference in its entirety.

As previously noted, in some embodiments, each consumer profile 208a, 208b, 208c may further include demographic characteristics 304. Such demographic characteristics 304 may include demographic data associated with the related consumer that may be used for the identification of coupons to be distributed to the related consumer. The demographic characteristics 304 may include age, gender, income, zip code, postal code, residential status, residential type, education, familial status, occupation, and other suitable demographics that will be apparent to persons having skill in the relevant art. In some embodiments, the demographic characteristics 304 may be received and stored in a consumer profile with the consent of the related consumer. In other embodiments, the demographic characteristics 304 may be designed to not include any personally identifiable information.

The coupon database 210 of the processing server 108 includes a plurality of coupon data entries 212 (212a, 212b, 212c). Each coupon data entry 212 is configured to include data related to a coupon including at least a coupon identifier and coupon data. In some embodiments, the coupon data entries 212, including the coupon identifier 307 may be received, by the receiving device 202, from the third party (e.g., retailer 112a, advertising agency 112b, coupon provider, etc.). In other embodiments, the coupon data entries 212 including the coupon identifier 307 may be created upon the processing server 108 receiving a request from the first device 102a of the first consumer 101a to forward a coupon. In yet other embodiments, the coupon data entries 212 may be created upon redemption of the coupon, by the second consumer 101b. For example, upon redemption of the coupon, by the second consumer 101b, a notification of redemption (e.g., included in an authorization request) may be transmitted from a merchant to the processing server 108. Upon receiving the notification of redemption, the processing device 204 may update the consumer database 110 so that the first and second consumer profiles 208a, 208b include the coupon forwarding data entry 306 and the coupon redemption data entry 310 (as previously discussed herein). Based on such information, the processing device 204 may create a coupon history information data entry 324 in the associated coupon data entry 212a in the coupon database 210. The coupon history information 324 stored in the associated coupon data entry 212a reflects forwarding information 326 and redemption information 328 of the corresponding coupon. It further includes any reward information 329 regarding rewards that were distributed to the first consumer 101a upon redemption of the coupon.

In some embodiments, as discussed in more detail herein, the coupon history information 324 may be transmitted to a third party (e.g., retailer 112a, advertising agency 112b, coupon distributor) upon a request from the third party. In other embodiments, coupon history information 324 may be used (e.g., by the processing server 108) to generate statistics, e.g., to be provided to a third party). For example, coupon history information of a plurality of redeemed coupon may be compared to information received in a request (for statistics) from a third party in order to generate applicable statistics. Such generated statistics may include, for example a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc. These statistics may then be utilized by the third party for the identification of (i) future coupons most likely to be redeemed by consumers, (ii) rewards that are most likely to incentivize consumers to forward coupons to appropriate individuals, etc.

### Process for the Forwarding and Redemption of a Coupon

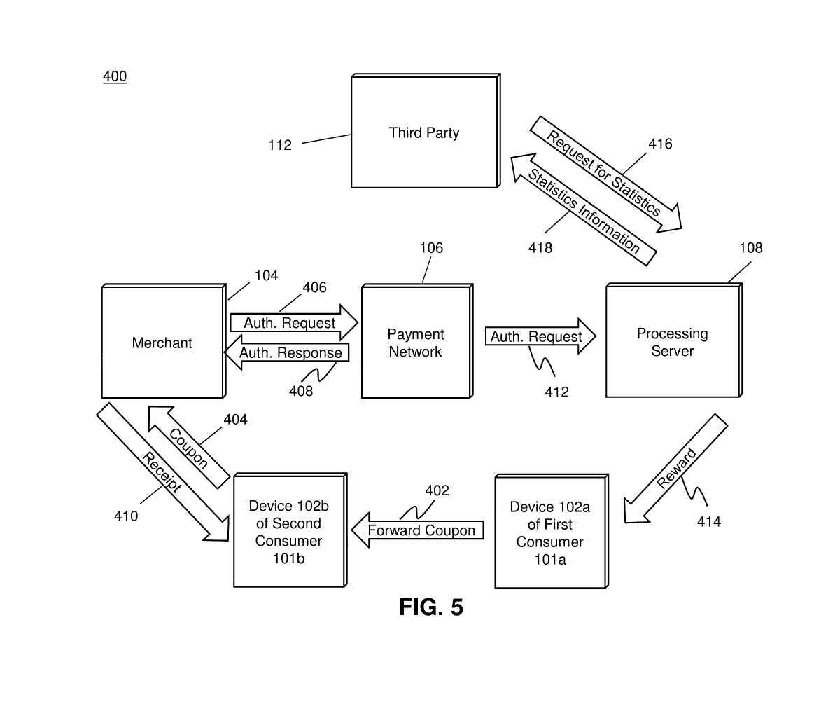

FIG. 5 illustrates a process 400, using the system 100 of FIG. 1, for the forwarding of coupons, redemption of coupons and the rewarding of consumers.

In step 402, a first consumer 101a forwards a coupon to a second consumer 101b. In some embodiments, the first consumer 101a (via a processing device/unit of their consumer device 101a) may forward the coupon to the device 102b of the second consumer 101b using social media (e.g., Facebook, Twitter, etc.). In other embodiments, the first consumer 101a may forward the coupon to the second consumer 101b via electronic mail. In yet other embodiments, the first consumer 101a may forward the coupon to the second consumer 101b by requesting the processing server 108 forward the coupon on behalf of the first consumer 101a. It is noted that the first consumer 101a may have obtained the coupon in any number of ways. For example, in some embodiments, the user may have received the coupon from a third party (e.g., a coupon provider). In other embodiments, the first consumer 101a may have received the coupon from the processing server 108. In other embodiments, the first consumer 101a may have received the coupon from another consumer (e.g., the coupon may have been forwarded to the first consumer 101a)

In step 404, the second consumer 101b may conduct a payment transaction with the merchant 104 and furnish the coupon for use in the transaction. In some embodiments (such as that depicted in FIG. 5), the second consumer 101a may use a payment card as the payment transaction. The merchant 104 is configured to discount the transaction using the coupon and in step 406, to submit (e.g., via an acquirer) an authorization request to the payment network 106. The authorization request may include transaction data for the payment transaction, the consumer identifier, and the coupon identifier. In some embodiments, the authorization request may also include coupon data for the redeemed coupon. The payment network 106 is configured to process the payment transaction using methods and systems that will be apparent to persons having skill in the relevant art, and, in step 408, to provide an authorization response indicating approval of the transaction to the merchant 104. In some embodiments, the payment network 106 may process the redemption of the coupon instead of the merchant 104 and may then process the payment transaction using traditional methods.

The merchant 104, in step 410, is configured to furnish a receipt and/or the transacted-for products to the second consumer 101b to finalize the transaction. Following the processing of the payment transaction, the payment network 106 may, in step 412, transmit a copy of the authorization request to the processing server 108. The processing server 108 may then use the consumer identifier and/or the coupon identifier included in the authorization request to identify and update the consumer profile 208b associated with the second consumer 101b (who received the forwarded coupon from the first consumer 101a) and the consumer profile 208a associated with the first consumer 101a (who forwarded the coupon to the second consumer 101b) to reflect appropriate forwarding and redemption information.

In step 414, the processing server 108 is configured to transmit a notification to the first device 102a of the first consumer 101a indicating that a forwarded coupon has been redeemed and providing a reward to the first consumer 101a for the forwarding and subsequent redemption of the coupon. The reward may include points, which may be used for, e.g., purchasing goods and/or services, receiving future, more advantageous offers, or receiving a cash reward. In some embodiments, if a plurality of rewards is provided to the first consumer 101a, from which he/she may select, upon selection of a reward, the first device 102a of the first consumer 101a may transmit a notification to the processing server 108 identifying the first consumer's selection. The processing server 108 may then store information regarding the selected reward.

In step 416, the processing server 108 is configured to receive a request for statistics (regarding information on redeemed coupons) from a third party (e.g., retailer 112a, advertising agency 112b, coupon provider, etc.). Such a request may include information upon which the generation of statistics (by the processing server 108) should be based, including at least one of a coupon category, a coupon type, a product category, a merchant category, a merchant, a manufacturer, types of rewards, etc.

In step 418, the processing server 108 is configured to generate statistics (regarding redeemed coupons) based on the information provided in the request from the third party and using information on redeemed coupons stored in the coupon database 210 and transmit such generated statistics to the third party. In particular, the processing server 108 may refer to coupon history information 324 stored in a plurality of coupon data entries 212a, 212b, 212c to generate statistics. Such generated statistics can include, for example, a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc. For example, a request from a third party may inquire which rewards appear to result in the most number of coupon forwards. Based on the information in such a request, the processing server 108 would refer to the forwarding information 326 and associated reward information 329 in each of a plurality of coupon data entries to generate statistics. The third party may then use the statistics provided by the processing server 108 to determine, for example, (1) which rewards are most likely to encourage the forwarding of coupons, (2) which coupons are more likely to be redeemed within a certain time period, etc.

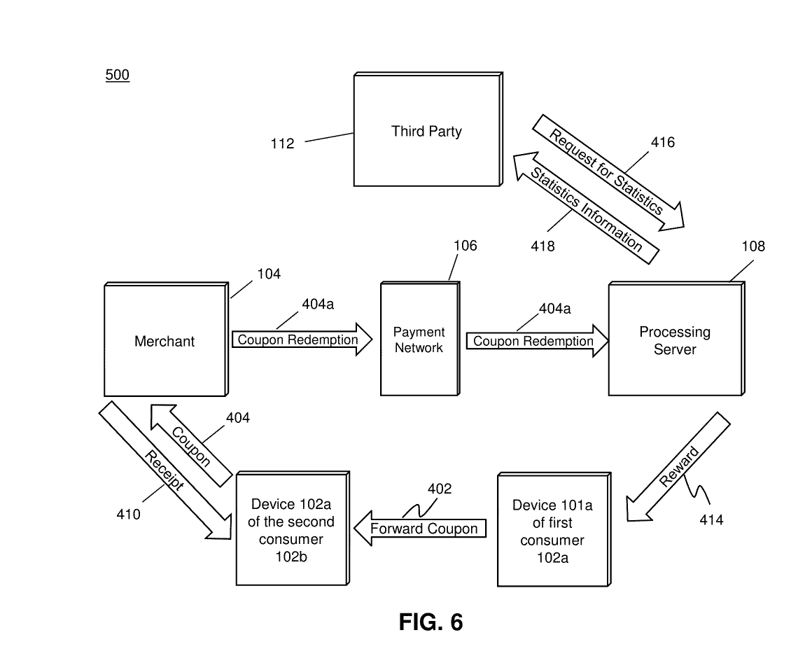

FIG. 6 illustrates a process 500, using the system 100 of FIG. 1, for the forwarding of coupons, redemption of coupons and the rewarding of consumers.

The process illustrated in FIG. 6 is similar to the process depicted in FIG. 5. However, in the process illustrated in FIG. 6, the second consumer 101b transacts with the merchant 104 using cash as the payment instrument. In step 402 (similar to FIG. 5), a first consumer 101a forwards a coupon to a second consumer 101b. Ways in which the first consumer 101a may forward the coupon to the second consumer 102a are previously discussed herein.

In step 404, the second consumer 101b may conduct a payment transaction with the merchant 104 and furnish the coupon for use in the transaction. In some embodiments (such as that depicted in FIG. 6), the second consumer 101a may use cash as the payment transaction. The merchant 104 is configured to discount the transaction using the coupon and in step 404a, to transmit a notification to the processing server 108 (via the payment network 106) indicating redemption of the coupon by the second consumer 101b. The notification may include at least the coupon identifier. In some embodiments, the notification may also include the unique identifier of the first consumer 101a. In yet other embodiments, the notification may also include the unique identifier of the second consumer 101b. In some embodiments, the payment network 106 may process the redemption of the coupon instead of the merchant 104. The processing server 108 may then use the coupon identifier and/or the unique consumer identifier(s) included in the redemption notification to identify and update the consumer profile 208b associated with the second consumer 101b (who received the forwarded coupon from the first consumer 101a) and the consumer profile 208a associated with the first consumer 101a (who forwarded the coupon to the second consumer 101b) to reflect appropriate forwarding and redemption information.

The merchant 104, in step 410, is configured to furnish a receipt and/or the transacted-for products to the second consumer 101b to finalize the transaction.

In step 414, the processing server 108 is configured to transmit a notification to the first device 102a of the first consumer 101a indicating that a coupon (the he/she had forwarded) has been redeemed and providing a reward (as previously discussed) to the first consumer 101a for the forwarding and subsequent redemption of the coupon. While not depicted, if a plurality of rewards is provided to the first consumer 101a, from which he/she may select, the first device 102a of the first consumer 101a may transmit a notification to the processing server 108 identifying the first consumer's selection. The processing server 108 may then store information regarding the selected reward.

Steps 416 and 418 are similar to steps 416 and 418 discussed above with respect to FIG. 5 and will therefore not be discussed in detail.

### Exemplary Methods for Distributing Coupons and Rewarding Consumers for Coupon Redemption

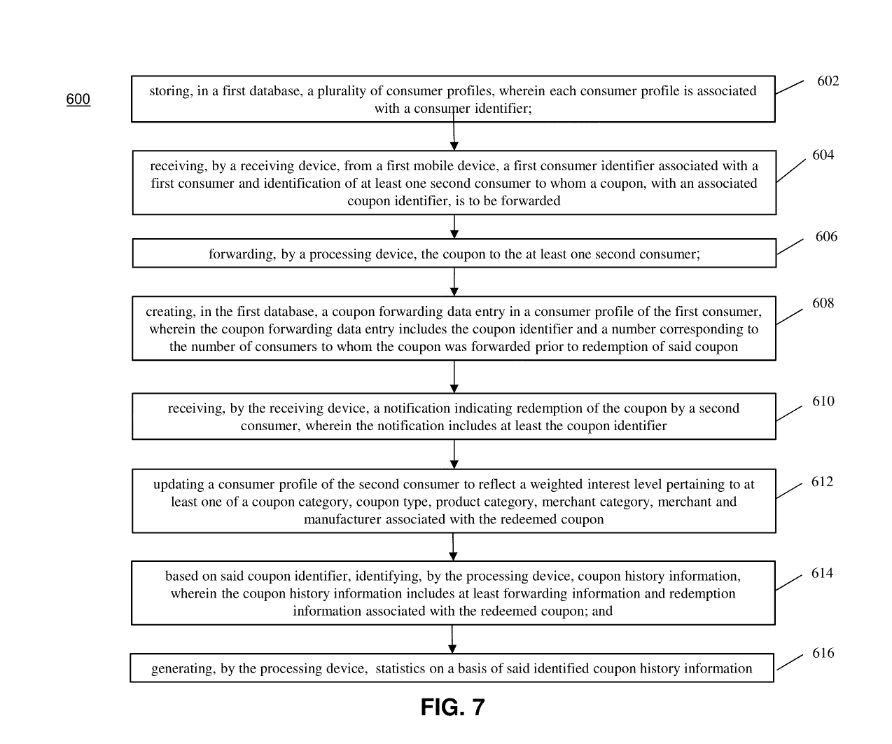

FIG. 7 illustrates an exemplary method 600 for the efficient distribution of coupons to consumers and the rewarding of consumers for coupon redemption. In step 602, a plurality of consumer profiles (e.g., the consumer profiles 208a, 208b, 208c) may be stored in a first database (e.g., the consumer database 110), wherein each consumer profile 208 is associated with a consumer identifier (e.g., consumer identifiers 302a, 302b, 302c).

In step 604, a first consumer identifier (302a) associated with a first consumer (e.g., first consumer 101a) and an identification of at least one second consumer (e.g., second consumer 101b) to whom a coupon, with an associated coupon identifier, is to be forwarded, is received by a receiving device (e.g., the receiving device 202).

In step 606, the coupon is forwarded, by a processing device, to at least the second consumer. For example, the processing device 204 of the processing server 108, may forward the coupon to at least the second consumer 101b on behalf of the first consumer 101a.

In step 608, a coupon forwarding data entry (e.g., coupon forwarding data 306) is created in a consumer profile of the first consumer (e.g., consumer profile 208a of the first consumer 101a) in the first database (e.g., consumer database 110). In some embodiments, the coupon forwarding data entry may include, for example, a coupon identifier (e.g., coupon identifier 307), a date of original forward (by the first consumer 101a), and a total number (e.g., forwarding total 308) associated with the number of people to whom the first consumer 101a forwarded the coupon. In some embodiments, the forwarding total may also reflect subsequent forwards by any of the second consumers. In some embodiments, the forwarding total may only reflect the total forwards prior to redemption of the coupon.

In step 610, upon coupon redemption by a second consumer (e.g., second consumer 101b), a notification indicating redemption of the coupon by the second consumer is received by the receiving device (e.g., receiving device 202). The redemption notification includes at least the coupon identifier (e.g., encoded coupon identifier 901 that corresponds to coupon identifier 307). In some embodiments, the redemption notification may also include at least an encoded unique identifier (e.g., 901a) that is associated with the first consumer (e.g., first consumer 101a). In some embodiments, the redemption notification may further include encoded unique identifiers (e.g., 901a, 901b) associated with both the first and second consumer (e.g., first consumer 101a and second consumer 101b). The redemption notification is transmitted from a merchant (e.g., merchant 104) to the processing server (e.g., processing server 108) upon the merchant reading the coupon (e.g., with a scanner) presented by the second consumer. In some embodiments, if the second consumer has used a payment card as the payment instrument, the redemption notification may be included in an authorization request sent from the merchant to the processing server.

In step 612, a consumer profile (e.g., consumer profile 208b) in the first database (e.g., consumer database 110) associated with the second consumer (e.g., second consumer 101b) may be updated to reflect a weighted interest level of the second consumer with respect to at least one of a coupon category, coupon type, product category, merchant category, merchant and manufacturer associated with the redeemed coupon. For example, in the consumer profile 208b of the second consumer 101b, information identifying the weighted interest level of the second consumer associated with the redeemed coupon is linked to the coupon identifier 307 associated with the redeemed coupon. In some embodiments, the consumer profile 208a of the first consumer 101a is updated such that a coupon redemption data entry (e.g., coupon redemption data entry 310) is created that corresponds to the redeemed coupon identifier. Such a coupon redemption data entry includes at least the coupon identifier and indicates that the coupon was redeemed. In some embodiments, the coupon redemption data may further indicate a total number of redemptions.

In step 614, coupon history information is identified from the consumer database (e.g., from the first and second consumer profiles 208a, 208b), by the processing device (e.g., processing device 204), using the coupon identifier. The coupon history information includes at least forwarding information (e.g., included in the coupon forwarding data entry 306) and redemption information (e.g., included in the coupon redemption data entry 310) associated with the redeemed coupon. In some embodiments, the coupon history information may further include reward information that is associated with redeemed coupon. In some embodiments, a coupon history information data entry (e.g., coupon history information data entry 324) may then be stored in the associated coupon data entry (e.g., coupon data entry 212a) in the coupon database 210.

In step 616, statistics regarding redeemed coupons may then be generated, by the processing device (e.g., processing device 204) on a basis of the coupon history information stored in the coupon database 210. In some embodiments, the generation of statistics may be further based on information received from a third party. For example, the processing device may receive a request for statistics from the third party. Such a request may include, for example, information regarding a coupon category, a coupon type, a product category, a merchant category, a merchant, a manufacturer, and/or a type of reward. Statistics may then be generated, for the third party, based on the information provided in the request and using information on redeemed coupons stored in the coupon database. Generated statistics may include, for example, a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc. These statistics may then be utilized by the third party for the identification of (i) future coupons most likely to be redeemed by consumers, (ii) rewards that are most likely to incentivize consumers to forward coupons to appropriate individuals, etc.

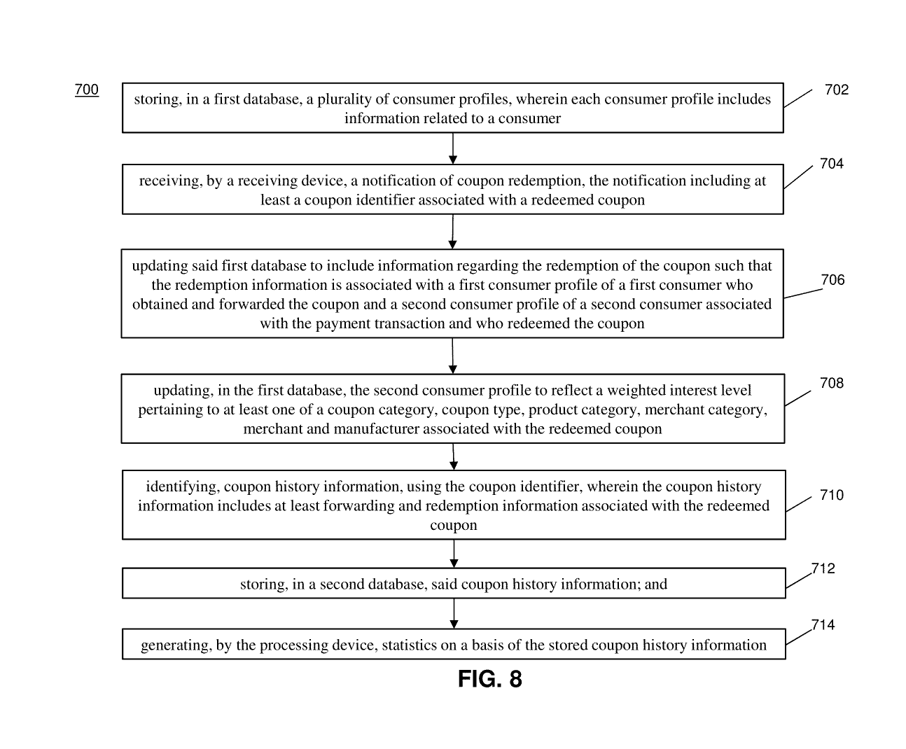

FIG. 8 illustrates an exemplary method 700 for the efficient distribution of coupons to consumers and the rewarding of consumers for coupon redemption. In step 702, a plurality of consumer profiles 208 (e.g., the consumer profiles 208a, 208b, 208c) may be stored in a first database (e.g., the consumer database 110). Each consumer profile 208 includes information related to a specific consumer. For example, each consumer profile may include consumer identifiers 302a, 302b, 302c of respective consumers.

In step 704, upon redemption of a coupon, a notification indicating redemption of the coupon is received by the receiving device (e.g., receiving device 202). The redemption notification includes at least the coupon identifier (e.g., encoded coupon identifier 901 that corresponds to coupon identifier 307). In some embodiments, the redemption notification may also include at least an encoded unique identifier (e.g., 901a) that is associated with the first consumer (e.g., first consumer 101a). In some embodiments, the redemption notification may further include encoded unique identifiers (e.g., 901a, 901b) associated with both the first and second consumer (e.g., first consumer 101a and second consumer 101b). The redemption notification is transmitted from a merchant (e.g., merchant 104) to the processing server (e.g., processing server 108) upon the merchant reading the coupon (e.g., with a scanner) presented by the second consumer. In some embodiments, if the second consumer has used a payment card as the payment instrument, the redemption notification may be included in an authorization request sent from the merchant to the processing server.

In step 706, the first database (e.g., consumer database 110) is updated to include information regarding the redemption of the coupon such that the redemption information is associated with a first consumer profile (e.g., consumer profile 208a) of a first consumer (e.g., first consumer 101a) who originally obtained and forwarded the coupon and a second consumer profile (e.g., consumer profile 208b) of a second consumer (e.g., second consumer 101b) associated with the payment transaction and who redeemed the coupon. For example, the first consumer profile associated with the first consumer (who originally received and forwarded the coupon) may be updated such that a coupon redemption data entry (e.g., coupon redemption data entry 310) is created that corresponds to the redeemed coupon identifier. Such a coupon redemption data entry may include at least the coupon identifier and may further indicate that the coupon was redeemed. In some embodiments, the coupon redemption data may further indicate a total number of redemptions.

In some embodiments, the consumer profile (e.g., consumer profile 208a) of the first consumer (e.g., first consumer 101a) is further updated to include a coupon forwarding data entry (e.g., coupon forwarding data 306). Such a coupon forwarding data entry may include, for example, a coupon identifier (e.g., coupon identifier 307), a date of original forward (by the first consumer 101a), and a total number (e.g., forwarding total 308) associated with the number of people to whom the first consumer 101a forwarded the coupon. In some embodiments, the forwarding total may also reflect subsequent forwards by any of the second consumers. In some embodiments, the forwarding total may only reflect the total forwards prior to redemption of the coupon.

In step 708, the consumer profile (e.g., consumer profile 208b) of the second consumer (e.g., second consumer 101b) is updated to reflect a weighted interest level of the second consumer with respect to at least one of a coupon category, coupon type, product category, merchant category, merchant and manufacturer associated with the redeemed coupon. For example, in the consumer profile 208b of the second consumer 101b, information identifying the weighted interest level of the second consumer associated with the redeemed coupon is linked to the coupon identifier 307 associated with the redeemed coupon.

In step 710, coupon history information is identified from the consumer databases (e.g., from the first and second consumer profiles 208a, 208b), by the processing device (e.g., processing device 204), using the coupon identifier. The coupon history information includes at least forwarding information (e.g., included in the coupon forwarding data entry 306) and redemption information (e.g., included in the coupon redemption data entry 310) associated with the redeemed coupon. In some embodiments, the coupon history information may further include reward information that is associated with redeemed coupon.

In step 712, a coupon history information data entry (e.g., coupon history information data entry 324) may then be stored in an associated coupon data entry (e.g., coupon data entry 212a) in the coupon database 210.

In step 714, statistics regarding redeemed coupons may then be generated, by the processing device (e.g., processing device 204) on a basis of the coupon history information stored in the coupon database (e.g. coupon database 210). In some embodiments, the generation of statistics may be further based on information received from a third party. For example, the processing device may receive a request for statistics from the third party. Such a request may include, for example, information regarding a coupon category, a coupon type, a product category, a merchant category, a merchant, a manufacturer, and/or a type of reward. Statistics may then be generated, for the third party, based on the information provided in the request and using information on redeemed coupons stored in the coupon database. Generated statistics may include, for example, a number times a coupon was forwarded before redeemed, an average number of forwards prior to redemption (for a plurality of related coupons), non-personally identifiable information indicating types of people with a propensity to redeem coupons, number of redemptions associated with a coupon, types of rewards that appear successful for encouraging the forwarding of coupons, etc. These statistics may then be utilized by the third party for the identification of (i) future coupons most likely to be redeemed by consumers, (ii) rewards that are most likely to incentivize consumers to forward coupons to appropriate individuals, etc.

### Advantage of the Disclosed Systems and Methods

The systems and methods as disclosed herein are at an advantage over conventional systems and methods in that a need does not exist to understand profiles (e.g., interests) of consumers to whom the system initially transmits coupons (e.g., the system may blindly transmit coupons to a plurality of different consumers). Rather, reliance is made upon the consumers, who have better insight regarding interests and/or needs of his/her circle of friends, family members, acquaintances, etc. than a third party predictive system could ever have, to forward a coupon to an appropriate individual that he/she may personally know who may possess a need for such a coupon. For example, a third party system would not necessarily be aware of the fact that a couple is expecting their first child (e.g., until it detects purchases made with a transaction card, registrations to certain forums or product categories, etc.). However, friends, family members, acquaintances of the couple may be aware of their expectance of their first child. As such any offer that the friends, family members acquaintances may have received that is relevant to that couple's life event (expecting a child) could be better steered via the disclosed systems (and related methods).

### Computer System Architecture

FIG. 10 illustrates a computer system 800 in which embodiments of the present disclosure, or portions thereof, may be implemented as computer-readable code. For example, the processing server 108 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 7 and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor 804 may be a special purpose or a general purpose processor device. The processor 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 7 and 8, as discussed herein. Accordingly, such computer programs may represent controllers of the computer system 800. Where the present disclosure is implemented using software, the software may be stored in a computer program product and loaded into the computer system 800 using the removable storage drive 814 interface 820, and hard disk drive 812, or communications interface 824.

The previous description of the various embodiments is provided to enable any person skilled in the art to make or use the invention recited in the accompanying claims of the disclosed systems and methods. While exemplary embodiments of the disclosed systems and methods have been particularly shown and described with reference to embodiments thereof, it should be understood by those skilled in the art that many variations, modifications and alternative configurations may be made to the invention without departing from the spirit and scope of exemplary embodiments of the disclosed systems and methods. The scope, however, of the methods and systems for efficiently distributing coupons to consumers is limited only by the meets and bounds as articulated in the claims appended hereto.

What is claimed is:

1. A method for efficiently distributing coupons to consumers and rewarding consumers for coupon redemption, the method comprising:
storing, in a first database of a financial system, a plurality of consumer profiles, wherein each consumer profile is associated with a consumer identifier;
receiving, by a receiving device, from a first mobile device of a first consumer, (i) a first consumer identifier associated with the first consumer and (ii) identification of at least one second consumer to whom a coupon, with an associated coupon identifier, is to be forwarded;
forwarding, by a processing device, the coupon to a second mobile device of the at least one second consumer;
creating, in the first database, a coupon forwarding data entry in a consumer profile of the first consumer, wherein said coupon forwarding data entry includes (i) the coupon identifier and (ii) a number corresponding to the number of consumers to whom the coupon was forwarded prior to redemption of said coupon;
receiving, by the receiving device, a notification indicating redemption of said coupon by a second consumer, wherein said notification includes at least the coupon identifier;
updating, in said first database, a consumer profile of the second consumer to reflect a weighted interest level pertaining to at least one of a coupon category, coupon type, product category, merchant category, merchant and manufacturer associated with the redeemed coupon;
based on said coupon identifier, identifying from the first database, by the processing device, coupon history information, wherein said coupon history information includes at least forwarding information and redemption information associated with said redeemed coupon; and
generating, by the processing device, statistics on a basis of said identified coupon history information.

2. The method according to claim 1, further comprising:
receiving, by the receiving device, an authorization request for a payment transaction, from a merchant, wherein the authorization request includes the notification of coupon redemption and a second consumer identifier associated with the second consumer.

3. The method according to claim 1, further comprising:
creating, in the first database, a coupon redemption data entry in (1) the consumer profile of the second consumer who redeemed the coupon and (2) the consumer profile of the first consumer who forwarded the coupon, wherein said coupon redemption data entry includes at least the coupon identifier and indicates that said coupon was redeemed.

4. The method of claim 1, further comprising:
prior to receiving, from the first mobile device, (i) the first consumer identifier associated with the first consumer and (ii) identification of the at least one second consumer to whom the coupon was forwarded, distributing, by the processing device, the coupon to a plurality of consumers.

5. The method of claim 1, further comprising:
storing, in a second database, said coupon history information in association with said coupon identifier, wherein said second database includes history information on a plurality of different redeemed coupons.

6. The method of claim 1, further comprising:
presenting, by the processing device, to the first mobile device of at least the first consumer, at least one reward for the forwarding and subsequent redemption of the coupon.

7. The method of claim 1, further comprising:
receiving, by the receiving device, a request for statistics information, from a third party, wherein the request includes information regarding at least one of: a coupon category, a coupon type, a product category, a merchant category, a merchant, and a manufacturer.

8. The method of claim 1, further comprising:
receiving, by the receiving device, a request for statistics information, from a third party, wherein the request includes information regarding at least one of: a coupon category, a coupon type, a product category, a merchant category, a merchant, and a manufacturer; and
generating said statistics by comparing coupon history information of a plurality of redeemed coupons on a basis of said information included request received from the third party.

9. The method of claim 1, wherein the generated statistics includes at least one of: (i) an average number of forwards prior to redemption, (ii) non-personally identifiable information indicating types of people with a propensity to redeem coupons, (iii) types of rewards that encourage the forwarding of coupons.

10. A method for efficiently distributing coupons to consumers and rewarding consumers for coupon redemption, comprising:
storing, in a first database, a plurality of consumer profiles, wherein each consumer profile includes information related to a consumer;
receiving, by a receiving device, a notification of coupon redemption, said notification including at least a coupon identifier associated with a redeemed coupon;
updating said first database to include information regarding the redemption of said coupon such that said redemption information is associated with (1) a first consumer profile of a first consumer who obtained and forwarded the coupon and (2) a second consumer profile of a second consumer associated with the payment transaction and who redeemed the coupon;
updating, in said first database, the second consumer profile to reflect a weighted interest level pertaining to at least one of a coupon category, coupon type, product category, merchant category, merchant and manufacturer associated with the redeemed coupon;
identifying, by a processing device, coupon history information, using said coupon identifier, wherein said coupon history information includes at least forwarding information and redemption information associated with said redeemed coupon;
storing, in a second database, said coupon history information; and
generating, by the processing device, statistics on a basis of said stored coupon history information.

11. The method according to claim 10, wherein the notification of coupon redemption further includes a first identifier associated with the first consumer who forwarded the coupon and a second identifier associated with the at least one second consumer who redeemed the coupon.

12. The method according to claim 10, wherein
the notification of coupon redemption is included in an authorization request for a payment transaction, received from a merchant, and
the authorization request further includes a first identifier associated with the first consumer who forwarded the coupon and a second identifier associated with the at least one second consumer who redeemed the coupon.

13. The method of claim 10, wherein the second database includes history information on a plurality of different redeemed coupons.

14. The method of claim 10, further comprising:
prior to receiving the notification of coupon redemption, distributing, by the processing device, the coupon to a plurality of consumers.

15. The method of claim 10, further comprising:
presenting, by the processing device, to a mobile device of at least the first consumer, at least one reward for the forwarding and subsequent redemption of the coupon.

16. The method of claim 10, further comprising:
receiving, by the receiving device, a request for statistics information, from a third party, wherein the request includes information regarding at least one of: a coupon category, a coupon type, a product category, a merchant category, a merchant, and a manufacturer.

17. The method of claim 10, further comprising:
receiving, by the receiving device, a request for statistics information, from a third party, wherein the request includes information regarding at least one of: a coupon category, a coupon type, a product category, a merchant category, a merchant, and a manufacturer;
generating said statistics by comparing coupon history information of a plurality of redeemed coupons on a basis of said information included request received from the third party; and
transmitting said generated statistics information to said third party.

18. The method of claim 10, wherein the generated statistics includes at least one of: (i) an average number of forwards prior to redemption, (ii) non-personally identifiable information indicating types of people with a propensity to redeem coupons, (iii) types of rewards that encourage the forwarding of coupons.

19. A system for efficiently distributing coupons to consumers and rewarding consumers for coupon redemption, the system comprising:
a first database configured to store a plurality of consumer profiles, wherein each consumer profile is associated with a consumer identifier;
a receiving device configured to receive from a first mobile device of a first consumer, (i) a first consumer identifier associated with the first consumer and (ii) identification of at least one second consumer to whom a coupon, with an associated coupon identifier, is to be forwarded;
a processing device configured to
forward the coupon to the at least one second consumer,
create a coupon forwarding data entry in a consumer profile of the first consumer, wherein said coupon forwarding data entry includes (1) the coupon identifier and (2) a number corresponding to the number of consumers to whom the coupon was forwarded prior to redemption of said coupon;
upon redemption of said coupon by a second consumer, update a consumer profile of the second consumer to reflect a weighted interest level pertaining to at least one of a coupon category, coupon type, product category, merchant category, merchant and manufacturer associated with the redeemed coupon;
identify from the first database, using said coupon identifier, coupon history information, wherein said coupon history information includes at least forwarding information and redemption information associated with said redeemed coupon; and
generating statistics on a basis of said stored coupon history information.

20. The system according to claim 19, wherein the processing device is further configured to receive an authorization request for a payment transaction, from a merchant, wherein the authorization request includes at least the coupon identifier associated with a redeemed coupon and a second consumer identifier associated with a second consumer;

21. The system according to claim 19, further comprising:
a second database configured to store said coupon history information in association with said coupon identifier, wherein said second database includes history information on a plurality of different redeemed coupons.

22. The system according to claim 19, wherein the processing device is further configured to create, in the first database, a coupon redemption data entry in (i) the consumer profile of the second consumer who redeemed the coupon and (ii) the consumer profile of the first consumer who forwarded the coupon, wherein said coupon redemption data entry includes at least the coupon identifier and indicates that said coupon was redeemed.

23. The system according to claim 19, wherein the processing device is further configured to receive coupons from a third party and distribute the coupons to a plurality of consumers on behalf of the third party.

24. The system according to claim 19, wherein the processing device is further configured to receive the coupon from a mobile device of the first consumer, wherein the mobile device of the first consumer previously received the coupon from a third party.

25. The system according to claim 19, wherein the processing device is further configured to transmit, to the first mobile device of at least the first consumer, a reward for the forwarding and subsequent redemption of the coupon.

26. The system according to claim 19, wherein the receiving device is further configured to receive, from a third party, a request for statistics information, wherein the request includes information regarding at least one of: a coupon category, a coupon type, a product category, a merchant category, a merchant, and a manufacturer.

27. The system according to claim 26, wherein the processing device generates said statistics by comparing coupon history information of a plurality of redeemed coupons on a basis of said information included in the request received from the third party.

28. A system for efficiently distributing coupons to consumers and rewarding consumers for coupon redemption, the system comprising:
a first database configured to store a plurality of consumer profiles, wherein each consumer profile includes information related to a consumer;
a second database configured to store redeemed coupon history information;
a receiving device configured to receive a notification of coupon redemption including at least a coupon identifier associated with a redeemed coupon;
a processing device configured to
update said first database to include information regarding the redemption of said coupon such that said redemption information is associated with (i) a first consumer profile of a first consumer who obtained and forwarded the coupon and (ii) a second consumer profile of a second consumer who redeemed the coupon,
identify coupon history information, using said coupon identifier, wherein said coupon history information includes at least forwarding information and redemption information associated with said redeemed coupon,
update said second database to include said coupon history information of said redeemed coupon; and
generate statistics on a basis of said stored coupon history information.

29. The system according to claim 28, wherein
the notification of coupon redemption is included in an authorization request for a payment transaction, from a merchant, and
the authorization request further includes a first identifier associated with the first consumer who forwarded the coupon and a second identifier associated with the at least one second consumer who redeemed the coupon.

30. The system according to claim 28, wherein the processing device is further configured to receive coupons from a third party and distribute the coupons to a plurality of consumers on behalf of the third party.

31. The system according to claim 28, wherein the processing device is further configured to receive the coupon from a mobile device of the first consumer, wherein the mobile device of the first consumer previously received the coupon from a third party.

32. The system according to claim 28, wherein the processing device is further configured to transmit, to the first mobile device of at least the first consumer, a reward for the forwarding and subsequent redemption of the coupon.

33. The system according to claim 28, wherein the receiving device is further configured to receive, from a third party, a request for statistics information, wherein the request includes information regarding at least one of: a coupon category, a coupon type, a product category, a merchant category, a merchant, and a manufacturer.

34. The system according to claim 28, wherein the processing device generates said statistics by comparing coupon history information of a plurality of redeemed coupons on a basis of said information included in the request received from the third party.
